(19) United States
(12) Patent Application Publication
(10) Pub. No.: US 2009/0321541 A1
(43) Pub. Date: Dec. 31, 2009

(54) Multi-fan jet nozzle and fuel injector having a multi-fan jet nozzle

(76) Inventors: Volker Holzgrefe, Ditzingen (DE); Stefan Arndt, Stuttgart (DE); Christian Heinen, Leinfelden-Echterdingen (DE); Markus Gesk, Karlsbad (DE); Armin Schuelke, Rutesheim-Heuweg (DE); Guenter Dantes, Eberdingen (DE); Joerg Heyse, Besigheim (DE); Andreas Krause, Unterriexingen (DE); Kai Gartung, Stuttgart (DE)

Correspondence Address: KENYON & KENYON LLP, ONE BROADWAY, NEW YORK, NY, 10004, US

(21) Appl. No.: 11/794,651

(22) PCT Filed: Nov. 2, 2005
(86) PCT No.: PCT/EP05/55700

§ 371 Date: Sep. 15, 2009

(30) Foreign Application Priority Data
Jan. 3, 2005 (DE) 102005000620 5

(51) Int. Cl. B05B 1/14

(52) U.S. Cl. 239/553.3

(57) ABSTRACT

The fuel injector is characterized in that a multi-fan jet nozzle is disposed downstream of a valve-seat member having a fixed valve seat. The multi-fan jet nozzle is disk shaped, having a middle, bulged, crest-like nozzle area that has an elliptical elongation. In the nozzle area of the multi-fan jet nozzle used as an atomizer device, a plurality of directionally parallel spray-discharge slots is provided, which, for example, are arranged in a row. The fuel injector is particularly suitable for use in fuel-injection systems of mixture-compressing internal combustion engines having externally supplied ignition.

### BACKGROUND INFORMATION

The present invention relates to a multi-fan jet nozzle according to the species defined in Claim 1 and a fuel injector according to the species defined in Claim 7.

From the German patent DE 196 36 396 A1, a fuel injector is already known in which an apertured disk having a plurality of spray-discharge orifices is provided downstream of the valve-seat surface. The advantageously ten to twenty spray-discharge orifices are located in a plane of the apertured disk which runs perpendicular to the longitudinal valve axis. The largest portion of the spray-discharge orifices is introduced into the apertured disk at an angle or in inclined fashion, so that the orifice axes of the spray-discharge orifices have no parallelism with respect to the longitudinal valve axis. Since the inclinations of the spray-discharge orifices can be selected to be different, a divergence of the individual jets to be discharged is easily attainable. For example, the spray-discharge orifices are introduced in a largely uniform size into the apertured disk by laser-beam drilling. The fuel injector is particularly suited for fuel-injection systems of mixture-compressing internal combustion engines having externally supplied ignition.

A fuel injector in which a slot-shaped outlet orifice is provided at the downstream end is already known from DE 198 47 625 A1. The outlet orifice is either formed in an apertured disk or directly in the. nozzle body itself. The slot-shaped outlet orifices are always introduced centrally at the longitudinal valve axis, so that the fuel discharges from the fuel injector in axially parallel fashion. Upstream from the valve seat is a helical groove, which imparts a circular rotary motion to the fuel flowing to the valve seat. The flat outlet orifice ensures that the fuel is discharged in a fanlike manner.

The U.S. Pat. No. 6,019,296 A also describes a fuel injector for the direct injection of fuel into a combustion chamber of an internal combustion engine, in which at the downstream end, a slot-shaped outlet orifice is provided, from which fuel can discharge at an angle with respect to the longitudinal valve axis.

### SUMMARY OF THE INVENTION

The multi-fan jet nozzle of the present invention having the characterizing features of Claim 1 has the advantage that it permits the discharge of superfinely atomizing fluid sprays. Via the very close spray-discharge slots, a plurality of fan jets is produced which first of all leave the multi-fan jet nozzle parallel to one another, and with distance to the multi-fan jet nozzle, disintegrate into small droplets. Ideally, frontal collisions of partial flows of the fluid take place in the multi-fan jet nozzle upstream of the spray-discharge slots. The collisions take place transversely to the slot direction of the spray-discharge slots. As a reaction, fanlike spreadings in the flow develop in the spray-discharge slots. Upon leaving the spray-discharge slots, flat fan jets develop from the divergent flow which thin out sharply due to their spreadings, and from a certain disintegration distance onwards, disintegrate into suitably small droplets.

Advantageous further refinements of and improvements to the multi-fan jet nozzle indicated in Claim 1 are rendered possible by the measures delineated in the dependent claims.

It is particularly advantageous to manufacture the multi-fan jet nozzle microgalvanically in a single layer or with a plurality of structural levels. In this way, exactly reproducible spray-discharge slots having filigree orifice structures such as, for example, slot widths of approximately 20 to 100 μm, especially 20 to 50 μm, and slot lengths of up to 1 mm, especially less than 150 μm, may be produced easily and in large quantity.

The fuel injector of the present invention having the characterizing features of Claim 7 has the advantage that a uniform, superfine atomization of the fuel is achieve in a simple manner, a particularly high preparation quality and atomization quality with very small fluid droplets being attained. In ideal manner, at the downstream end of the fuel injector, the multi-fan jet nozzle has a plurality of very small, directionally parallel spray-discharge slots, so that fuel sprays having extremely small fuel droplets with a Sauter mean diameter (SMD) of approximately 20 μm are able to be discharged. In this way, it is possible to markedly reduce the HC emission of the internal combustion engine in very effective manner.

Advantageous further refinements of and improvements to the fuel injector indicated in Claim 7 are rendered possible by the measures delineated in the dependent claims.

Ideally, the multi-fan jet nozzle is a micro-apertured disk having a plurality of very small spray-discharge slots, each having a slot width of approximately 20 to 100 μm. The spray-discharge slots are arranged in parallel, lined up in rows, and at the same time, distributed as uniformly as possible and covering a large area over a, e.g., rounded nozzle area. Due to this distribution, the volumetric flow to be atomized per individual discharge slot is correspondingly small.

### BRIEF DESCRIPTION OF THE DRAWING

Exemplary embodiments of the present invention are depicted in simplified fashion in the drawing and explained in greater detail in the description below.

FIG. 1 shows a partially depicted valve in the form of a fuel injector having an exemplary embodiment of a multi-fan jet nozzle in a sectional view;

FIG. 2 shows the valve end having the multi-fan jet nozzle according to FIG. 1 in a sectional view rotated by 90°;

FIG. 3 shows the multi-fan jet nozzle in a view according to FIG. 2;

FIG. 4 shows the multi-fan jet nozzle in a view according to FIG. 1;

FIG. 5 shows the multi-fan jet nozzle in a bottom view;

FIG. 6 shows a second design of a multi-fan jet nozzle in a bottom view;

FIG. 7 shows the multi-fan jet nozzle according to FIG. 6 in a side view;

FIG. 8 shows a third design of a multi-fan jet nozzle in a bottom view;

FIG. 9 shows a fourth design of a multi-fan jet nozzle in a bottom view;

FIG. 10 shows a first symbolic tool for producing a multi-fan jet nozzle;

FIG. 11 shows a second symbolic tool for producing a multi-fan jet nozzle;

FIG. 12 shows a cutting through a microgalvanically produced fifth multi-fan jet nozzle;

FIG. 13 shows a sectional view of a cutting along the line XIII-XIII in FIG. 12;

FIG. 14 shows a sixth design of a multi-fan jet nozzle in a partial bottom view;

FIG. 15 shows a cutting through a seventh design of a multi-fan jet nozzle along a sectional plane corresponding to FIG. 13;

FIG. 16 shows a cutting through an eighth design of a multi-fan jet nozzle along a sectional plane corresponding to FIG. 13; and

FIG. 17 shows a cross-section through a one-layer electrodeposited multi-fan jet nozzle in the area of a discharge slot.

### DESCRIPTION OF THE EXEMPLARY EMBODIMENTS

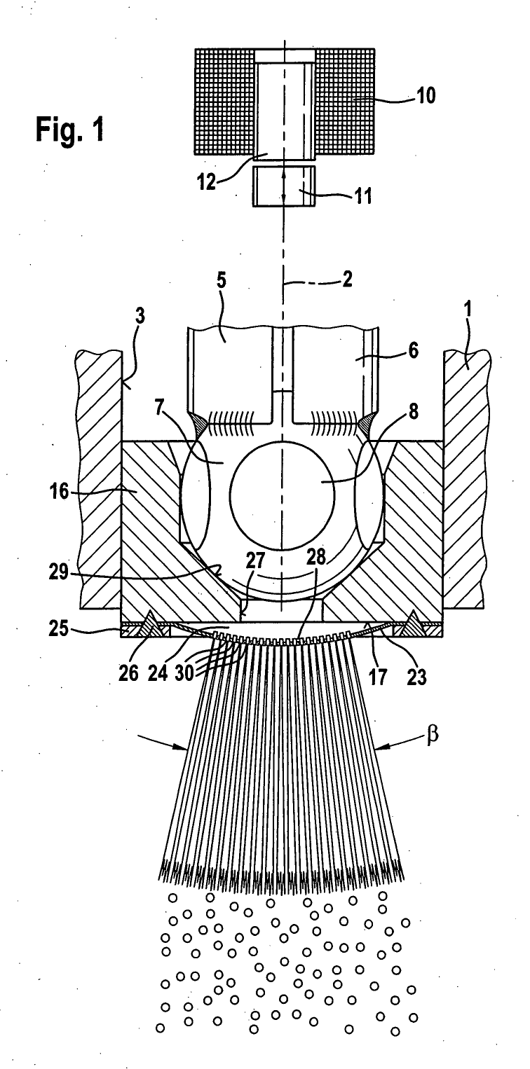

As an exemplary embodiment, FIG. 1 shows a partial view of a valve in the form of an injection valve for fuel injection systems of mixture-compressing internal combustion engines having externally supplied ignition. The fuel injector has a tubular valve-seat support 1, indicated only schematically, which forms a part of a valve housing, and in which a longitudinal opening 3 is formed concentrically with respect to a longitudinal valve axis 2. Situated in longitudinal opening 3 is a, for example, tubular valve needle 5, which is securely joined at its downstream end 6 to a, for instance, spherical valve-closure member 7, at whose periphery, five flattenings 8, for example, are provided for the fuel to flow past.

The fuel injector is actuated in a known manner, e.g. electromagnetically. However, actuation of the fuel injector by a piezoelectric or magnetostrictive actuator is conceivable, as well. A schematically indicated electromagnetic circuit including a solenoid coil 10, an armature 11 and a core 12 is used for axially moving valve needle 5, and thus for opening against the spring tension of a return spring (not shown) and for closing the fuel injector. Armature 11 is joined to the end of valve needle 5 facing away from valve-closure member 7 by, for instance, a welded seam formed by a laser, and is aligned with core 12.

A valve-seat member 16 is mounted in leak-proof manner by welding, for example, in the downstream end of valve-seat support 1. A multi-fan jet nozzle 23 of the present invention is secured as an atomizer device at lower end face 17 of valve-seat member 16 facing away from valve-closure member 7. Valve-seat member 16 and multi-fan jet nozzle 23 are joined, e.g., by a circumferential and impervious welded seam 26, formed by a laser, which, for example, is provided at end face 17 or at the outer periphery of valve-seat member 16 and multi-fan jet nozzle 23. To reliably secure very thin, disk-shaped multi-fan jet nozzle 23 to valve-seat member 16, a supporting disk 25 extends under multi-fan jet nozzle 23. Supporting disk 25 is ring-shaped, in order to accommodate a middle, dome-shaped or bulged-out, crest-like nozzle area 28 of multi-fan jet nozzle 23 in an inner opening.

The insertion depth of valve-seat member 16 with multi-fan jet nozzle 23 in longitudinal opening 3 determines the magnitude of the lift of valve needle 5, since the one end position of valve needle 5 when solenoid coil 10 is not energized is determined by the contact of valve-closure member 7 against a valve-seat surface 29 of valve-seat member 16, valve-seat surface 29 tapering conically in a downstream direction. When solenoid coil 10 is energized, the other end position of valve needle 5 is determined, e.g., by the contact of armature 11 against core 12. Therefore, the path between these two end positions of valve needle 5 constitutes the lift.

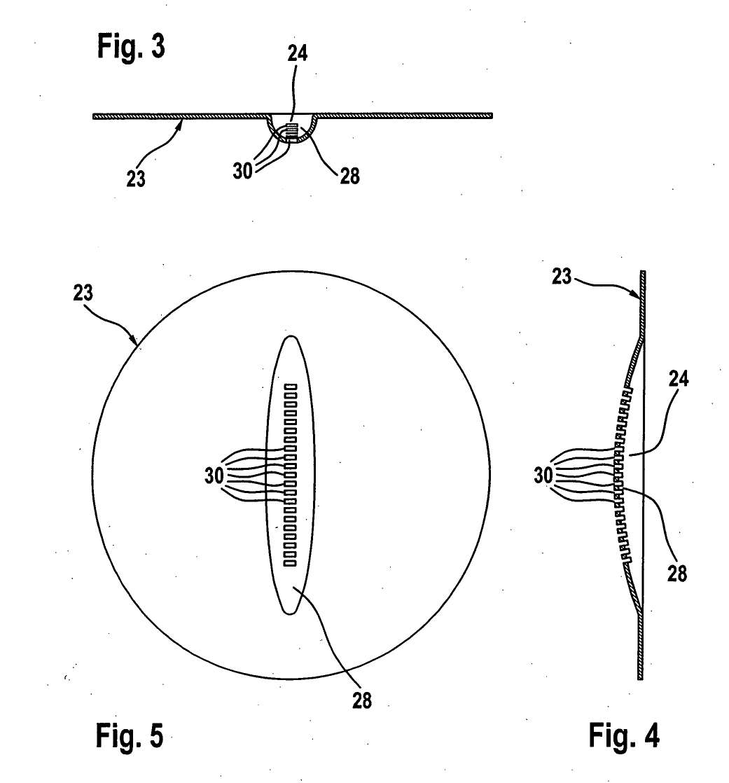

Provided in valve-seat member 16 downstream of valve-seat surface 29 is an outlet orifice 27, from which fuel to be discharged enters a flow cavity 24, which is formed by the rounded or dome-shaped construction of nozzle area 28 of multi-fan jet nozzle 23. In this context, multi-fan jet nozzle 23 has its greatest distance to end face 17 in the area of longitudinal valve axis 2, for example, while in the area of welded seam 26, multi-fan jet nozzle 23 abuts as a thin disk without curvature directly against valve-seat member 16, and is stabilized by supporting disk 25. Given a sufficiently pressure-stable and thick construction of microgalvanically produced multi-fan jet nozzle 23, it is also possible to do without a supporting disk 25 completely. The formation of nozzle area 28 becomes clear chiefly in FIGS. 3 through 5.

Ideally, a multitude of very small spray-discharge slots 30, which run in directionally parallel fashion, are provided in multi-fan jet nozzle 23, and particularly in its nozzle area 28. Spray-discharge slots 30 have a slot width of, in each case, approximately 20 to 100 μm, particularly 20 to 50 μm, and a slot length of up to 1 mm, particularly less than 150 μm, so that fuel spray having extremely small fuel droplets with a Sauter mean diameter (SMD) of approximately 20 μm is able to be discharged. In this way, it is possible to markedly reduce the HC emission of the internal combustion engine in very effective manner compared to known injection systems. Between two and sixty spray-discharge slots 30 are provided per multi-fan jet nozzle 23, a number from eight to forty spray-discharge slots 30 bringing optimum atomization results.

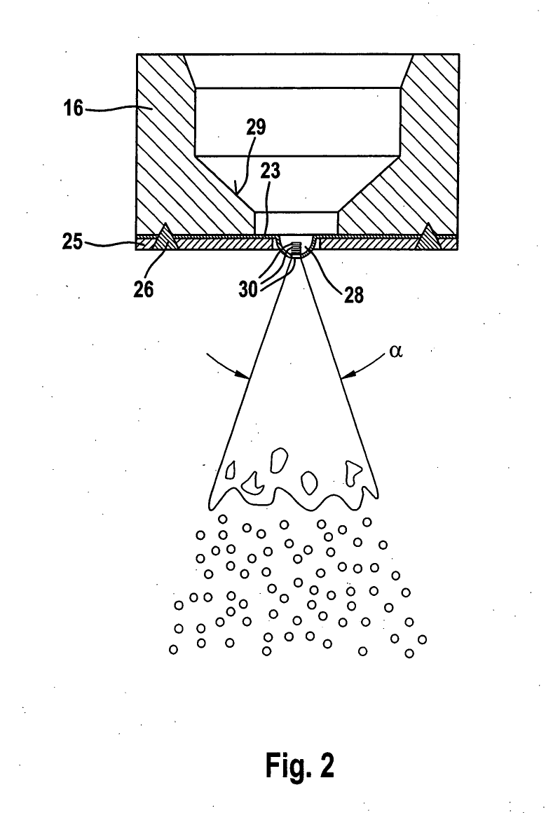

FIG. 2 shows the downstream valve end of the fuel injector having multi-fan jet nozzle 23 according to FIG. 1 in a side view rotated by 90°. In this case, it becomes particularly clear that middle nozzle area 28 has an elongated, elliptical shape. While, for example, the discharged fuel spray in its longitudinal alignment according to FIG. 1 has an exterior angle β with approximately 15°, an exterior angle α of the fuel spray in its transverse alignment according to FIG. 2 is approximately 30°. Thus, a fuel spray having an elliptical jet cross-section which disintegrates into superfine droplets is delivered via nozzle area 28 having the many spray-discharge slots 30.

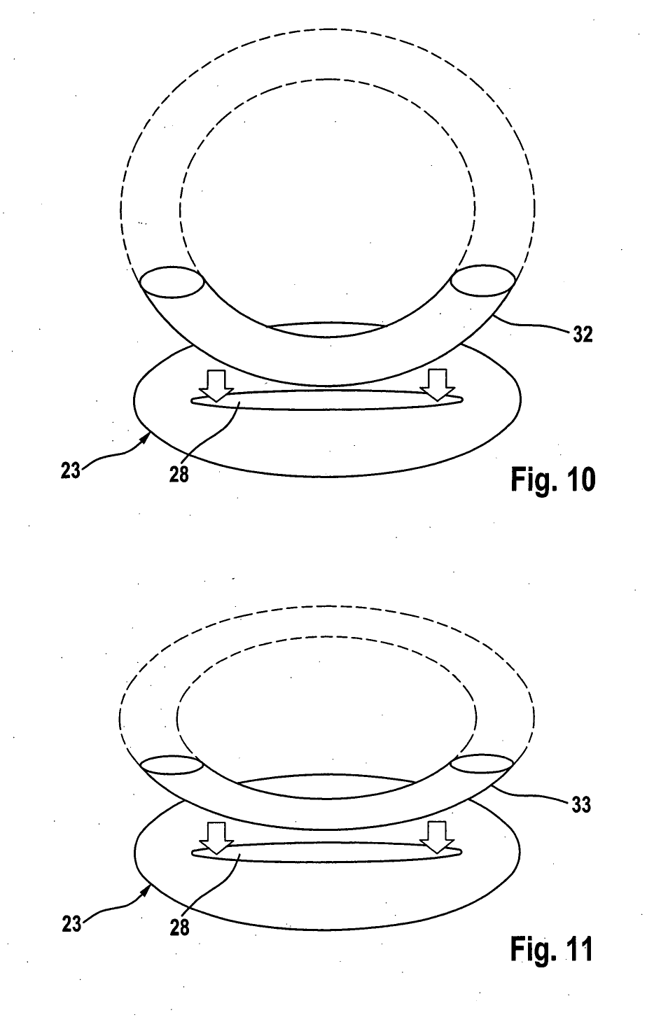

FIGS. 3, 4 and 5 show multi-fan jet nozzle 23 according to FIGS. 1 and 2 in side views, as well as in a bottom view, again as a single component. In this first exemplary embodiment, spray-discharge slots 30 are centrally located in nozzle area 28, and are each formed with identical shape and size. Spray-discharge slots 30 may have the cross-sectional shape of a rectangle, an elongated hole, an ellipse, a lens or others, the ratio of length to the greatest width of spray-discharge slots 30 being >=2:1. For example, two adjacent spray-discharge slots 30 have a spacing of approximately 40 to 300 μm. Thus, the distance from slot center to slot center is approximately 100 to 400 μm. Advantageously, multi-fan jet nozzle 23 is produced microgalvanically in an electrodeposition site. Due to this manufacturing technology, spray-discharge slots 30 have walls running perpendicular to the disk surface. After the disk has been produced galvanically, middle nozzle area 28 having spray-discharge slots 30 is formed, for example, using stamping techniques. Two stamping tools 32, 33 for producing nozzle area 28 of multi-fan jet nozzle 23 are shown symbolically in FIGS. 10 and 11, tool 32 shown in FIG. 10 being circular ring-shaped or partially circular ring-shaped, and tool 33 shown in FIG. 11 being elliptical or partially elliptical. In this context, the camber of nozzle area 28 is formed convexly pointing in the discharge direction. The disk of multi-fan jet nozzle 23 is advantageously made of nickel, which is very ductile, thus is very easy to deform during stamping without tears in the material.

In the bottom view, the camber of nozzle area 28 has an elliptical cross-section. For example, spray-discharge slots 30 are lined up equidistantly and in parallel to one another on the longitudinal axis of the ellipse. The longitudinal axes of spray-discharge slots 30 are perpendicular to the longitudinal axis of the ellipse. The camber of nozzle area 28 has a smaller radius of curvature (e.g., 0.25 mm) along its width than the radius of curvature along its length (e.g., 10 mm), as FIGS. 3 and 4 show clearly. Spray-discharge slots 30 run with their longitudinal axes along the sharper curvature, and therefore are strongly convexly curved in the discharge direction. As a result of this curvature, the flow emerging per discharge slot 30 emerges as a flat jet fan (FIG. 2). Fan-out angle a results from the curvature and the run length of spray-discharge slots 30. Each jet fan emerges perpendicular to the surface of the camber. Consequently, a uniform directional spread is achieved between the individual jet fans. The total spread angle corresponds to spray angle β (FIG. 1). Spray angles α and β determine the cross-section of the overall spray and are variable as desired. Therefore, the aspect ratio of the overall spray may be adapted individually, for example, to the geometry of an intake manifold.

FIG. 17 shows by way of example a cross-section through a multi-fan jet nozzle 23, electrodeposited in one layer, in the area of a discharge slot 30, in which the walls of discharge slot 30 do not run perpendicularly, but rather are curved in a trumpet shape over the entire boundary of discharge slot 30. Such a multi-fan jet nozzle 23 is produced by first of all depositing two photoresist layers on top of one another onto a substrate member. In so doing, the second resist layer is only applied after the first resist layer has been masked, exposed to light and structured. After the second resist layer has been masked, exposed to light and structured, both resist layers are developed in one step, that is, unexposed places in the resist layers are removed using a wet chemical treatment.

Graduated resist towers remain as residual of the resist layers on the substrate member at the exposed locations, and specifically precisely at the locations at which spray-discharge slots 30 of multi-fan jet nozzle 23 are to be formed. In the first resist layer, the resist tower has a markedly greater width than in the second resist layer, which, however, in return, is applied in markedly greater height.

In a following process step, metal is electrodeposited onto the substrate member around the resist towers in a single-stage process. The galvanic layer initially grows from the substrate member high on the first resist layer, and overgrows this first resist layer at its surface until the galvanic layer completely contacts the periphery of the second resist layer. The electrodeposition is stopped at the moment at which a small galvanic-layer thickness is present at the periphery of the second resist layer. Due to the overgrowth of the first resist layer, a funnel-shaped indentation in the galvanic layer results around the second resist layer in the area of each resist tower (“lateral overgrowth”). This indentation at each resist tower forms a diverging part of respective discharge slot 30.

After the removal of the resist towers (stripping) and of the substrate member, a single-layer multi-fan jet nozzle 23 is present having a plurality of spray-discharge slots 30. As arrow 31 indicates, in the incorporated state, spray-discharge slots 30 of multi-fan jet nozzle 23 are traversed by flow, for example, contrary to the direction of the galvanic growth. The narrowest width of discharge slot 30 lies in the range of approximately 30 to 100 μm. Given this pressure-stable and thick construction of microgalvanically produced multi-fan jet nozzle 23, it is possible to do without a supporting disk 25 completely. In this production using two resist layers, for example, spray-discharge slots 30 are obtained which, downstream of their narrowest width, have enlarged discharge contours that, in a bottom view of spray-discharge slots 30, form a kind of slot-shaped frame about each discharge slot 30.

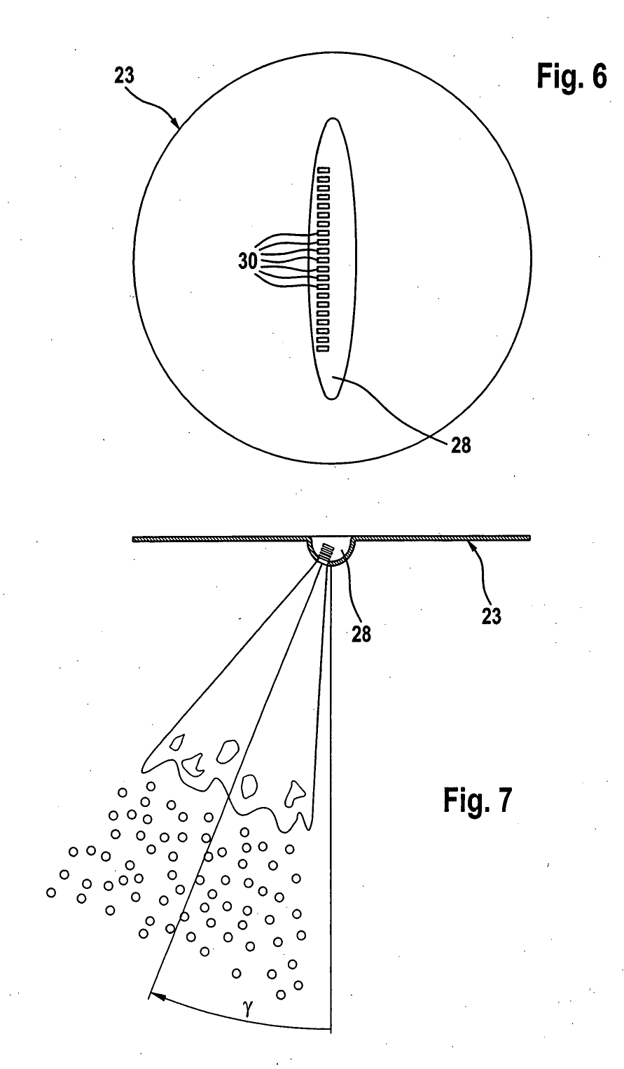

FIG. 6 shows a second construction of a multi-fan jet nozzle 23 in a bottom view, and FIG. 7 shows multi-fan jet nozzle 23 according to FIG. 6 in a side view. In this case, a multi-fan jet nozzle 23 discharging at an angle is involved. The spray formation is tilted by an angle γ. This is achieved by arranging all spray-discharge slots 30 so that their center is eccentric with respect to the longitudinal axis of the ellipse of nozzle area 28. In the exemplary embodiment shown, all spray-discharge slots 30 have the same center offset.

The construction according to FIG. 5 may be varied in such a way that the camber of nozzle area 28 having spray-discharge slots 30 is placed off-center on multi-fan jet nozzle 23, spray-discharge slots 30 being disposed centrally on the camber of nozzle area 28, however. The transverse flow against the camber of nozzle area 28 produces a γ-angle of the discharged spray here, as well.

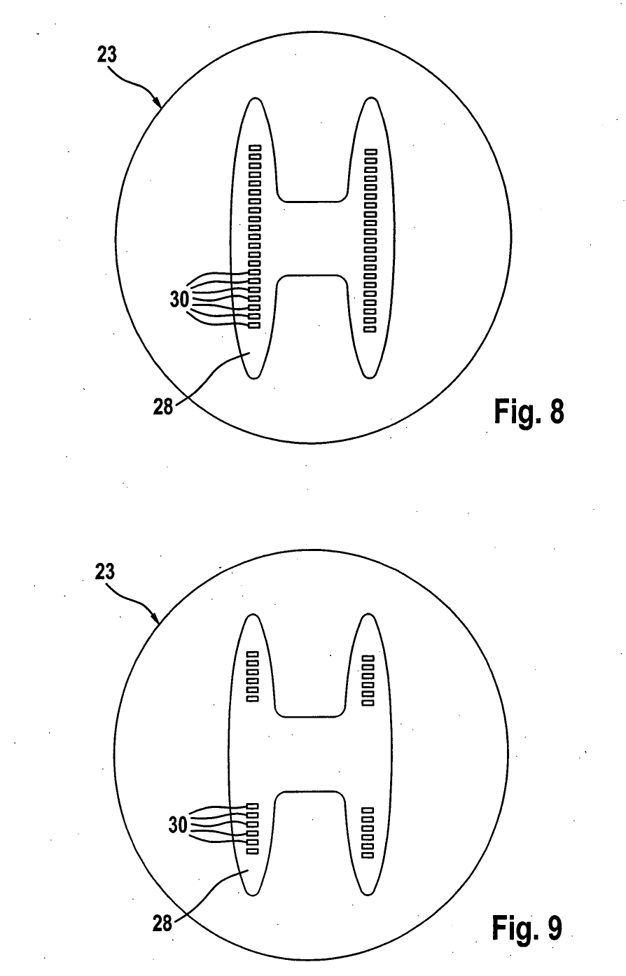

FIGS. 8 and 9 show a third and fourth design of a multi-fan jet nozzle 23 in a bottom view. In this case, the overall cross-section of nozzle area 28 is H-shaped. The H-shape is formed from two cambers running parallel to each other, each of which corresponds, for example, to a camber known from FIG. 5. Spray-discharge slots 30 are disposed in these two cambers of nozzle area 28. To prevent individual fan jets from the two cambers from contacting each other outside of the fuel injector, spray-discharge slots 30 are offset centrically relative to each other between both cambers. Both cambers are interconnected by a third, transversely running camber. The third camber is situated centrally with respect to outlet orifice 27, receives the fuel coming from outlet orifice 27, and distributes it to the two cambers provided with spray-discharge slots 30, from where the fuel is discharged. Spray-discharge slots 30 may be provided over the entire length of the cambers (FIG. 8), or only in partial areas of the cambers (FIG. 9). A spray gap is able to be produced by the example of multi-fan jet nozzle 23 shown in FIG. 9. The overall spray formation assumes a two-spray characteristic, which may be advantageous for internal combustion engines having two intake valves per cylinder.

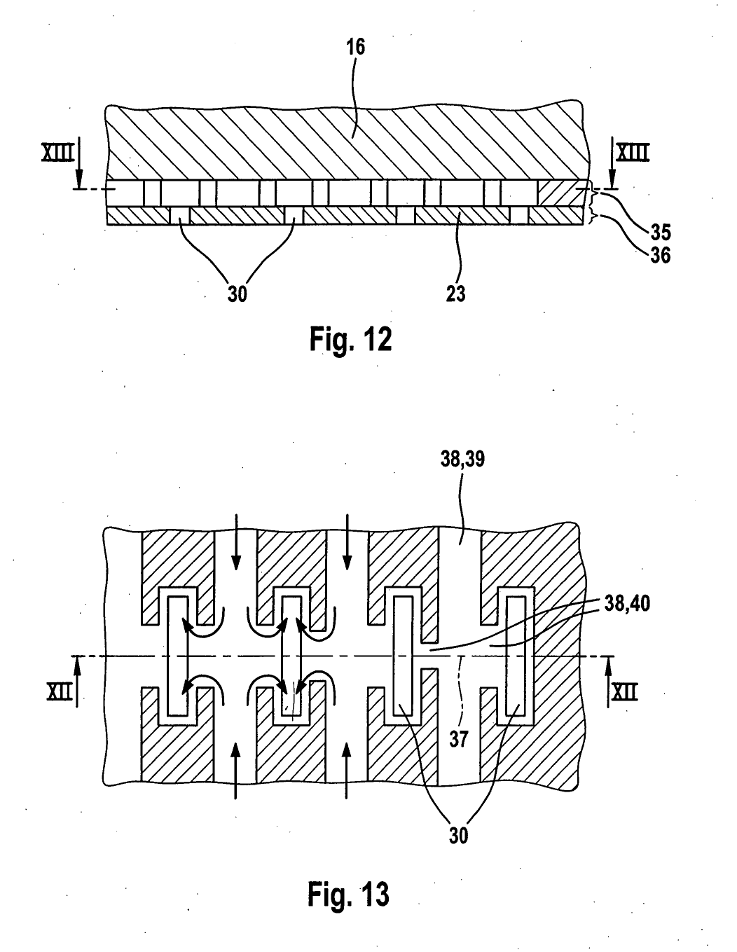

FIG. 12 shows a cutting through a microgalvanically produced fifth multi-fan jet nozzle 23, which is mounted on a valve-seat member 16. Multi-fan jet nozzle 23 is made up of two structural levels 35, 36. FIG. 13 is a sectional view of a cutting along line XIII-XIII in FIG. 12, thereby permitting a top view of spray-discharge slots 30. In contrast to the exemplary embodiments presented till now, multi-fan jet nozzle 23 has a continuously flat disk shape without cambers in a special nozzle area 28. Orifice contours differing from each other with respect to size and shape are present in both structural levels 35, 36. However, spray-discharge slots 30 in lower structural level 36 basically lie below cross sections traversed by flow in upper structural level 35. Spray-discharge slots 30 are situated centrically with their longitudinal axes and at a right angle with respect to an axis of symmetry 37, and are arranged in a row in directionally parallel fashion relative to each other along this axis of symmetry 37, as a rule being equidistant from each other.

In upper structural level 35, flow channels 38 are provided, which represent openings within microgalvanically deposited structural level 35. The fuel is directed horizontally through flow channels 38 in structural level 35 to spray-discharge slots 30. In so doing, each discharge slot 30 is fed from two adjacent flow channels 38 (see arrows in FIG. 13). Consequently, centrally and upstream of spray-discharge slots 30, there is a frontal collision of two partial flows from two opposite directions. The collision takes place transversely to the slot direction of discharge slot 30. Fanlike spreadings of the flow develop as reaction in spray-discharge slots 30. Upon leaving discharge slot 30, a flat fan jet develops from the divergent flow, which due to its spreading, thins out sharply, and from a certain disintegration distance onwards, disintegrates into suitably small droplets. Flow channels 38 of upper structural level 35 form a cross-shaped grid, which on one hand, is made up of supply channels 39 that run parallel to spray-discharge slots 30, and which on the other hand are adjoined by inflow channels 40 at right angles thereto. Above spray-discharge slots 30, material walls of upper structural level 35 do not run directly aligned with respect to the walls of spray-discharge slots 30 in lower structural level 36, but rather with a slight offset to the outside, so that spray-discharge slots 30 are able to receive flow from all sides. By varying the widths of supply channels 39 and/or of inflow channels 40 within one and the same multi-fan jet nozzle 23, fan jets may be tilted in the manner desired.

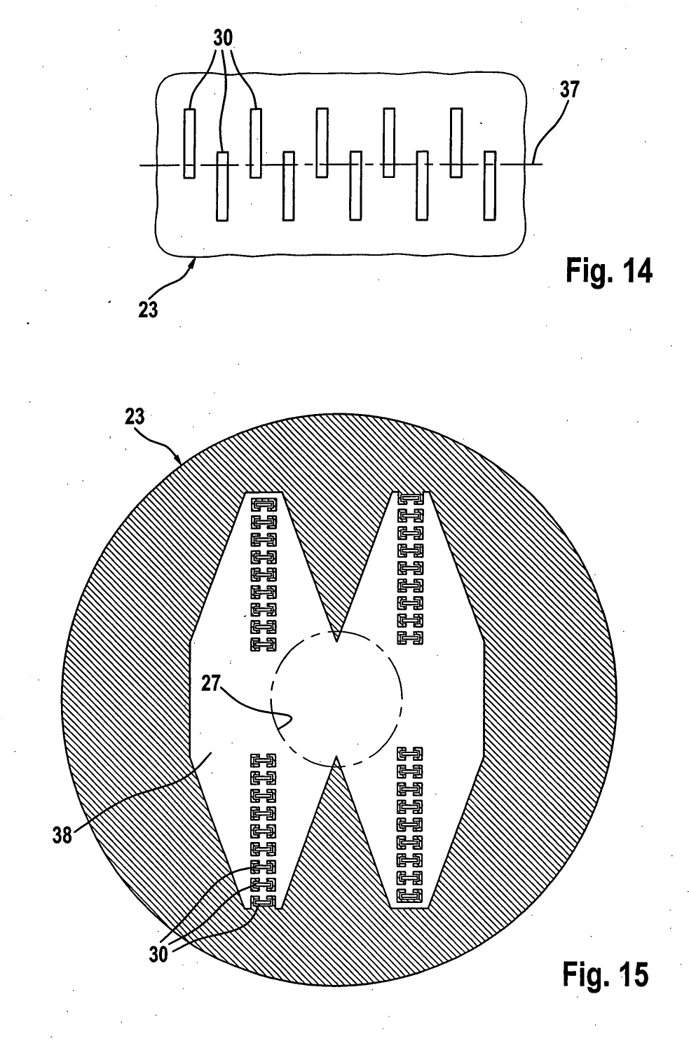

FIG. 14, using a sixth construction of a multi-fan jet nozzle 23 in a partial bottom view, clarifies that spray-discharge slots 30 may also be disposed eccentrically with respect to axis of symmetry 37, with offset at regular intervals, irregularly, on one side or in alternating fashion.

Multi-fan jet nozzle 23 is microgalvanically produced in a manner that upper structural level 35 is deposited first, and subsequently lower structural level 36. The electrodeposition is started on a flat, electroconductive bottom surface (substrate). A first photoresist layer is applied on the substrate. Thereupon, a selective exposure of the first photoresist layer using UV light and a partial, structured covering by a photomask are implemented. The pattern of the later structural level 35 is imaged. A sputter layer is then deposited in planar fashion onto the first photoresist layer. A second photoresist layer is subsequently applied. Thereupon, a selective exposure of the second photoresist layer using UV light and a partial, structured covering by a photomask are implemented. The pattern of the later structural level 36 is imaged. Both resist layers are subsequently developed in one step, that is, unexposed places are removed using a wet chemical treatment. Graduated resist structures remain on the substrate at the locations where opening structures are to be present later within multi-fan jet nozzle 23. Thereafter, the electrodeposition is carried out. As soon as the electrodeposition in structural level 35 exceeds the thickness of the photoresist layer, it comes into electrical contact with the sputter layer on this photoresist layer. The galvanic growth is started on the sputter layer as of this moment. The electrodeposition is stopped before it has reached the upper side of the photoresist layer belonging to structural level 36. Finally, the galvanic layer is removed from the substrate, and the photoresist is dissolved out.

FIG. 15 shows a cutting through a seventh design of a multi-fan jet nozzle 23 along a sectional plane corresponding to FIG. 13. The position of multi-fan jet nozzle 23 relative to valve-seat member 16 is made clear by the marking in of outlet orifice 27. In upper structural level 35, a large-area flow channel 38 is provided here, which again resembles the shape of an H. Two rows of mutually parallel spray-discharge slots 30 are accommodated in lower structural level 36. Both rows are offset relative to each other with regard to their subdivision into spray-discharge slots 30. A center offset is advantageously set, at which spray-discharge slots 30 of the one row are centrally offset with respect to those of the other row. In this way, the fan jets emerging from both rows are prevented from uniting at some distance from multi-fan jet nozzle 23. For example, both rows are disposed symmetrically with respect to the center of multi-fan jet nozzle 23.

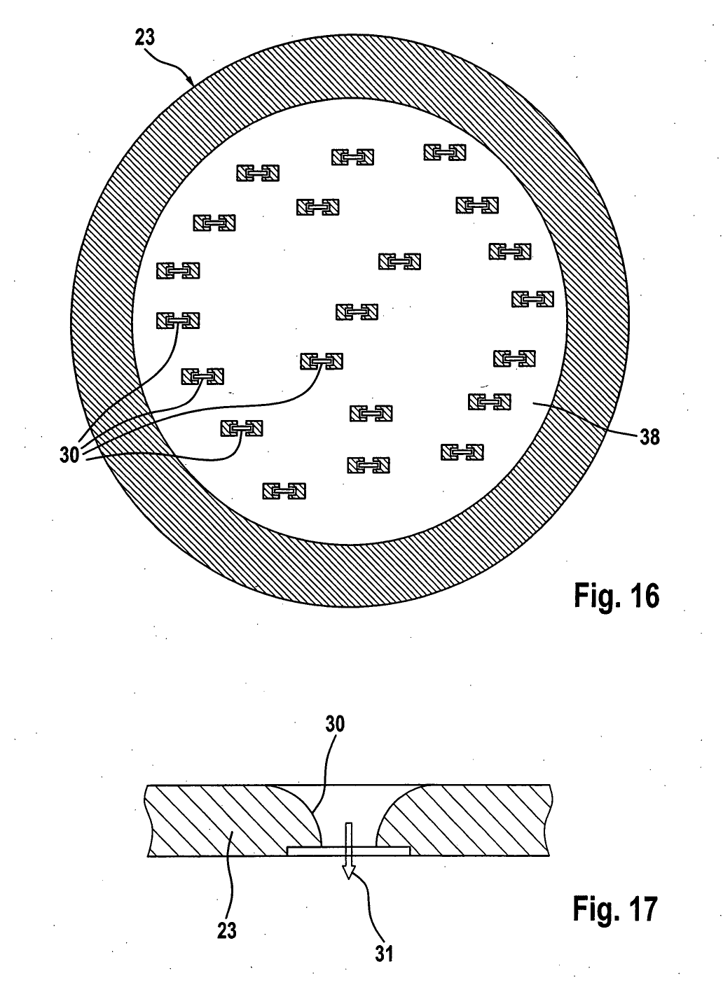

FIG. 16 shows a cutting through an eighth design of a multi-fan jet nozzle 23 along a sectional plane corresponding to FIG. 13. In this case, the surface of multi-fan jet nozzle 23 is utilized to the maximum, in order to have the greatest possible distance between adjacent fan jets. The danger of two adjacent fan jets sucking each other in is thereby reduced. Flow channel 38 is circular. All spray-discharge slots 30 are distributed in disordered manner and are offset relative to each other. This ensures that the emerging fan jets do not overlap in the discharge space in a manner damaging to the atomization. Given this arbitrary distribution of spray-discharge slots 30, they are, however, disposed in directionally parallel fashion.

In the exemplary embodiments of multi-fan jet nozzles 23 described, the widths and lengths of spray-discharge slots 30 are constant in a respective multi-fan jet nozzle 23. However, the widths and lengths of spray-discharge slots 30 may also vary within a multi-fan jet nozzle 23. This yields new possibilities in the shaping of the spray. For example, spray-discharge slots 30 in the center of a row of spray-discharge slots 30 may be wider than at the two ends of such a row. In this manner, larger flow rates may also be provided under restricted spatial conditions. The center of the overall spray comes less into contact with the wall of the intake manifold, which is why the drops in the center of the spray are allowed to be larger without greater danger of film formation on the wall of the intake manifold.

However, a multi-fan jet nozzle 23 according to the present invention is by no means limited to an application to a fuel injector. Rather, such a multi-fan jet nozzle 23 may be applied to any form of nozzles in which a discharge of fluids in fan-jet form is required or desired, the fluids then disintegrating into superfine atomized droplets. Fields of application are, for example, chemistry, agriculture, painting/varnishing technique or heating engineering.

1-18. (canceled)

19. A multi-fan jet nozzle as an atomizer device for emitting a finely atomized fluid, having a plurality of spray-discharge orifices and a plurality of directionally parallel spray-discharge slots (30).

20. The multi-fan jet nozzle according to claim 19, wherein the multi-fan jet nozzle (23) is disk-shaped.

21. The multi-fan jet nozzle according to claim 19, wherein the spray-discharge slots (30) each have a slot width of approximately 20 to 100 μm and a slot length of up to 1 mm.

22. The multi-fan jet nozzle according to claim 19, wherein two to sixty spray-discharge slots (30) are provided in the multi-fan jet nozzle (23).

23. The multi-fan jet nozzle according to claim 19, wherein the spray-discharge slots (30) have a cross-sectional shape of a rectangle, an ellipse or a lens.

24. The multi-fan jet nozzle according to claim 19, wherein the multi-fan jet nozzle (23) can be produced microgalvanically.

25. A fuel injector for a fuel injection system of an internal combustion engine, comprising: a longitudinal valve axis (2), a valve-seat member (16) having a fixed valve seat (29), having a valve-closure member (7) that cooperates with the valve seat (29) and is axially movable along the longitudinal valve axis (2), having an outlet orifice (27) in the valve-seat member (16), and an atomizer device disposed downstream from the valve seat (29), wherein the atomizer device is a multi-fan jet nozzle (23) having a plurality of directionally parallel spray-discharge slots (30).

26. The fuel injector according to claim 25, wherein the multi-fan jet nozzle (23) is disk-shaped.

27. The fuel injector according to claim 26, wherein the multi-fan jet nozzle (23) has a dome-shaped or bulged-out nozzle area (28) having the spray-discharge slots (30).

28. The fuel injector according to claim 26, wherein the multi-fan jet nozzle (23) includes at least two structural levels (35, 36).

29. The fuel injector according to claim 25, wherein the multi-fan jet nozzle (23) is securely joined to the valve-seat member (16).

30. The fuel injector according to claim 25, wherein the multi-fan jet nozzle (23) is secured to the valve-seat member (16) using a supporting disk (25).

31. The fuel injector according to claim 25, wherein the spray-discharge slots (30) each have a slot width of approximately 20 to 100 μm and a slot length of up to 1 mm.

32. The fuel injector according to claim 25, wherein the spray-discharge slots (30) each have a slot width of approximately 20 to 100 μm and a slot length of up to 1 mm.

33. The fuel injector according to claim 25, wherein two to sixty spray-discharge slots (30) are provided in the multi-fan jet nozzle (23).

34. The fuel injector according to claim 25, wherein the spray-discharge slots (30) have a cross-sectional shape of a rectangle, an ellipse or a lens.

35. The fuel injector according to claim 25, wherein a plurality of spray-discharge slots (30) is disposed in at least one row.

36. The fuel injector according to claim 25, wherein immediately upstream of the spray-discharge slots (30), a flow cavity (24) or one or more flow channels (38) are provided in the multi-fan jet nozzle (23).

37. The fuel injector according to claim 25, wherein the multi-fan jet nozzle (23) can be produced microgalvanically.
